(19) United States
(12) Patent Application Publication
(10) Pub. No.: US 2019/0059046 A1
(43) Pub. Date: Feb. 21, 2019

(54) Measurement Configurations in Unsynchronized Deployments

(71) Applicant: Nokia Solutions and Networks Oy, Espoo (FI)

(72) Inventors: Elena VIRTEJ, Espoo (FI); Jari LUNDEN, Espoo (FI); Lars DALSGAARD, Oulu (FI); Claudio ROSA, Randers (DK); Frank FREDERIKSEN, Klarup (DK)

(21) Appl. No.: 16/078,729

(22) PCT Filed: Feb. 14, 2017
(86) PCT No.: PCT/EP2017/053200

§ 371 Date: Aug. 22, 2018

(30) Foreign Application Priority Data
Feb. 26, 2016 (EP) PCT/EP2016/054156

(51) Int. Cl. H04W 48/16; H04L 5/00; H04W 24/10; H04W 74/08; H04W 72/04

(52) U.S. Cl. CPC H04W 48/16; H04L 5/005; H04W 16/14; H04W 74/0808; H04W 72/0446; H04W 24/10

(57) ABSTRACT

A method including receiving information indicative of a discovery signal timing measurement configuration including a first measurement phase associated with a first periodicity and at least one second measurement phase associated with a second periodicity, and using the discovery signal measurement configuration for measurement reporting.

### FIELD

The present invention relates to the field of wireless communications. More specifically, the present invention relates to methods, apparatus, systems and computer programs for configuring measurements in unsynchronized deployments.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters, which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimizing the 3GPP LTE radio access technologies.

Communication systems may be configured to use a mechanism for aggregating radio carriers to support wider transmission bandwidth. In LTE this mechanism is referred to as carrier aggregation (CA) and can, according to LTE Rel. 12 specifications, support a transmission bandwidth up to 100 MHz. A communication device with reception and/or transmission capabilities for CA can simultaneously receive and/or transmit on multiple component carriers (CCs) corresponding to multiple serving cells, for which the communication device has acquired/monitors system information needed for initiating connection establishment. When CA is configured, the communication device has only one radio resource control (RRC) connection with the network. At RRC connection establishment/reestablishment or handover, one serving cell provides the non-access stratum (NAS) mobility information, such as tracking area identity information. At RRC connection (re)establishment or handover, one serving cell provides the security input. This cell is referred to as the primary serving cell (PCell), and other cells are referred to as the secondary serving cells (SCells). Depending on capabilities of the communication device, SCells can be configured to form together with the PCell a set of serving cells under CA. In the downlink, the carrier corresponding to the PCell is the downlink primary component carrier (DL PCC), while in the uplink it is the uplink primary component carrier (UL PCC). A SCell needs to be configured by the network using RRC signaling before usage in order to provide necessary information, such as DL radio carrier frequency and physical cell identity (PCI) information, to the communication device. A SCell for which such necessary information has been provided to a communication device is referred to as configured cell for this communication device. The information available at the communication device after cell configuration is in particular sufficient for carrying out cell measurements. A configured SCell is in a deactivated state after cell configuration for energy saving. When a SCell is deactivated, the communication device does in particular not monitor/receive the physical dedicated control channel (PDCCH) or enhanced physical dedicated control channel (EPDCCH) or physical downlink shared channel (PDSCH) in the SCell. In other words the communication device cannot communicate in a SCell after cell configuration, and the SCell needs to be activated before data transmission from/the communication device can be initiated in the SCell. LTE provides for a mechanism for activation and deactivation of SCells via media access control (MAC) control elements to the communication device.

Communication systems may be configured to support simultaneous communication with two or more access nodes. In LTE this mechanism is referred to as dual connectivity (DC). More specifically, a communication device may be configured in LTE to communicate with a master eNB (MeNB) and a secondary eNB (SeNB). The MeNB may typically provide access to a macrocell, while the SeNB may provide on a different radio carrier access to a relatively small cell, such as a picocell. Only the MeNB maintains for the communication device in DC mode a connection via an S1-MME interface with the mobility management entity (MME), that is, only the MeNB is involved in mobility management procedures related to a communication device in DC mode. LTE supports two different user plane architectures for communication devices in DC mode. In the first architecture (split bearer) only the MeNB is connected via an S1-U interface to the serving gateway (S-GW) and the user plane data is transferred from the MeNB to the SeNB via an X2 interface. In the second architecture the SeNB is directly connected to the S-GW, and the MeNB is not involved in the transport of user plane data to the SeNB. DC in LTE reuses with respect to the radio interface concepts introduced for CA in LTE. A first group of cells, referred to as master cell group (MCG), can be provided for a communication device by the MeNB and may comprise one PCell and one or more SCells, and a second group of cells, referred to as seconday cell group (SCG), is provided by the SeNB and may comprise a primary SCell (PSCell) with functionality similar to the PCell in the MCG, for example with regard to uplink control signaling from the communication device. This second group of cells may further comprise one or more SCells.

Future networks, such as 5G, may progressively integrate data transmissions of different radio technologies in a communication between one or more access nodes and a communication device. Accordingly, communication devices may be able to operate simultaneously on more than one radio access technology, and carrier aggregation and dual connectivity may not be limited to the use of radio carriers of only one radio access technology. Rather, aggregation of radio carriers according to different radio access technologies and concurrent communication on such aggregated carriers may be supported.

Small cells, such as picocells, may progressively be deployed in future radio access networks to match the increasing demand for system capacity due to the growing population of communication devices and data applications. Integration of radio access technologies and/or a high number of small cells may bring about that a communication device may detect more and more cells in future networks, which are suitable candidates for connection establishment. Enhancements of carrier aggregation and dual connectivity mechanisms may be needed to make best use of these cells in future radio access networks. Such enhancements may allow for an aggregation of a high number of radio carriers at a communication device, for example up to 32 are currently specified in LTE Rel. 13, and in particular an integration of radio carriers operated on unlicensed spectrum.

Aggregation of radio carriers for communication to/from a communication device and simultaneous communication with two or more access nodes may in particular be used for operating cells on unlicensed (license exempt) spectrum. Wireless communication systems may be licensed to operate in particular spectrum bands. A technology, for example LTE, may operate, in addition to a licensed band, in an unlicensed band. LTE operation in the unlicensed spectrum may be based on the LTE Carrier Aggregation (CA) framework where one or more low power secondary cells (SCells) operate in the unlicensed spectrum and may be either downlink-only or contain both uplink (UL) and downlink (DL), and where the primary cell (PCell) operates in the licensed spectrum and can be either LTE Frequency Division Duplex (FDD) or LTE Time Division Duplex (TDD).

Two proposals for operating in unlicensed spectrum are LTE Licensed-Assisted Access (LAA) and LTE in Unlicensed Spectrum (LTE-U). LTE-LAA specified in 3GPP as part of Rel. 13 and LTE-U as defined by the LTE-U Forum may imply that a connection to a licensed band is maintained while using the unlicensed band. Moreover, the licensed and unlicensed bands may be operated together using, e.g., carrier aggregation or dual connectivity. For example, carrier aggregation between a primary cell (PCell) on a licensed band and one or more secondary cells (SCells) on unlicensed band may be applied, and uplink control information of the SCells is communicated in the PCell on licensed spectrum.

In an alternative proposal stand-alone operation using unlicensed carrier only may be used. In standalone operation at least some of the functions for access to cells on unlicensed spectrum and data transmission in these cells are performed without or with only minimum assistance or signaling support from license-based spectrum. Dual connectivity operation for unlicensed bands can be seen as an example of the scenario with minimum assistance or signaling from licensed-based spectrum.

Unlicensed band technologies may need to abide by certain rules, e.g. a clear channel assessment procedure, such as Listen-Before-Talk (LBT), in order to provide fair coexistence between LTE and other technologies such as Wi-Fi as well as between LTE operators. In some jurisdictions respective rules may be specified in regulations. In LTE-LAA, before being permitted to transmit, a user or an access point (such as eNodeB) may, depending on rules or regulatory requirements, need to perform a Clear Channel Assessment (CCA) procedure, such a Listen-Before-Talk (LBT). The user or access node may, for example, monitor a given radio frequency, i.e. carrier, for a short period of time to ensure that the spectrum is not already occupied by some other transmission. The requirements for CCA procedures, such as LBT, vary depending on the geographic region: e.g. in the US such requirements do not exist, whereas in e.g. Europe and Japan the network elements operating on unlicensed bands need to comply with LBT requirements. Moreover, CCA procedures, such as LBT, may be needed in order to guarantee co-existence with other unlicensed band usage in order to enable e.g. fair co-existence with Wi-Fi also operating on the same spectrum and/or carriers. After a successful CCA procedure the user or access point is allowed to start transmission within a transmission opportunity. The maximum duration of the transmission opportunity may be preconfigured or may be signaled in the system, and may extend over a range of 4 to 13 milliseconds. The access node may be allowed to schedule downlink (DL) transmissions from the access node and uplink (UL) transmissions to the access node within a certain time window. An uplink transmission may not be subject to a CCA procedure, such as LBT, if the time between a DL transmission and a subsequent UL transmission is less than or equal to a predetermined value. Moreover, certain signaling rules, such as Short Control Signaling (SCS) rules defined for Europe by ETSI, may allow for the transmission of control or management information without LBT operation, if the duty cycle of the related signaling does not exceed a certain threshold, e.g. 5%, within a specified period of time, for example 50 ms. The aforementioned SCS rules, for example, can be used by compliant communication devices, referred to as operating in adaptive mode for respective SCS transmission of management and control frames without sensing the channel for the presence of other signals. The term “adaptive mode” is defined in ETSI as a mechanism by which equipment can adapt to its environment by identifying other transmissions present in a band, and addresses a general requirement for efficient operation of communications systems on unlicensed bands. Further, scheduled UL transmissions may in general be allowed without LBT, if the time between a DL transmission from an access node and a subsequent UL transmission is less than or equal to a predetermined value, and the access node has performed a clear channel assessment procedure, such as LBT, prior to the DL transmission. The total transmission time covering both DL transmission and subsequent UL transmission may be limited to a maximum burst or channel occupancy time. The maximum burst or occupancy time may be specified, for example, by a regulator.

Data transmission on an unlicensed band or/and subject to a clear channel assessment procedure cannot occur pursuant to a predetermined schedule in a communication system. Rather, communication devices and access nodes need to determine suitable time windows for uplink transmission and/or downlink transmission. A respective time window may comprise one or more transmission time intervals (TTI), such as subframes in LTE, and is in the following referred to as uplink transmission opportunity or downlink transmission opportunity. A TTI is the time period reserved in a scheduling algorithm for performing a data transmission of a dedicated data unit in the communication system. The determination of uplink transmission opportunities and/or downlink transmission opportunities may be based on parameters related to the communication system, such as a configured pattern governing the sequence of uplink and downlink transmissions in the system. The determination may further be based on rules or regulations specifying a minimum and/or maximum allowed length of uplink transmissions and/or downlink transmissions. The determination of uplink and downlink opportunities may in particular be based on the outcome of a clear channel assessment procedure, and communication devices or access nodes will only start data transmission on a frequency band after having assessed that the frequency band is clear, that is, not occupied by data transmissions from other communication devices or access nodes. Further rules or regulations may govern data transmissions in a communication between an access node and one or more communication devices. These rules may, for example, specify a maximum length of a time window in the communication covering at least one transmission in a first direction, for example in DL in a cellular system from an access node of a cell, and at least one subsequent transmission in the reverse direction, for example in UL from one or more communication devices in the cell. Such a time window comprising one or more DL and UL transmissions is in the following referred to as communication opportunity. DL transmissions may comprise scheduling information which may be transmitted on a DL control channel. The scheduling information may in particular be used for scheduling one or more UL data transmissions and/or one or more DL data transmissions within the current one or more future communication opportunities.

Scheduling information for a data transmission is indicative of an assignment of contents attributes, format attributes and mapping attributes to the data transmission. Mapping attributes relate to one or more channel elements allocated to the transmission on the physical layer. Specifics of the channel elements depend on the radio access technology and may depend on the used channel type. A channel element may relate to a group of resource elements, while each resource element relates to a frequency attribute, for example a subcarrier index (and the respective frequency range) in a system employing orthogonal frequency-division multiplexing (OFDM), and a time attribute, such as the transmission time of an OFDM or Single-Carrier FDMA symbol. A channel element may further relate to a code attribute, such as a cover code or a spreading code, which may allow for parallel data transmission on the same set of resource elements. Illustrative examples for channel elements in LTE are control channel elements (CCE) on the physical downlink control channel (PDCCH) or the enhanced physical downlink control channel (EPDCCH), PUCCH resources on the physical uplink control channel (PUCCH), and physical resource blocks (PRB) on the physical downlink shared channel (PDSCH) and the physical uplink shared channel (PUSCH). It should be understood that each data transmission is associated with the code attributes of the allocated channel elements and the frequency and time attributes of the resource elements in the allocated channel elements. Format attributes relate to the processing of a set of information bits in the transmission prior to the mapping to the allocated channel elements. Format attributes may in particular comprise a modulation and coding scheme used in the transmission and the length of the transport block in the transmission. Contents attributes relate to the user/payload information conveyed through the transmission. In other words, a contents attribute is any information, which may in an application finally affect the arrangement of a detected data sequence at the receiving end. Contents attributes may comprise the sender and/or the receiver of the transmission. Contents attributes may further relate to the information bits processed in the transmission, for example some kind of sequence number in a communication. Contents attributes may in particular indicate whether the transmission is a retransmission or relates to a new set of information bits. In case of a hybrid automatic repeat request (HARQ) scheme contents attributes may in particular comprise an indication of the HARQ process number, that is, a HARQ-specific sequence number, the redundancy version (RV) used in the transmission and a new data indicator (NDI).

Scheduling information for a data transmission need not comprise assignment information for the complete set of attributes needed in the data transmission. At least a part of the attributes can be preconfigured, for example through semi-persistent scheduling, and can be used in more than one data transmission. Some of the attributes may be signaled implicitly or may be derivable, for example from timing information. However, dynamic scheduling in a more complex system, such as a cellular mobile network, requires transmission of scheduling information on a DL control channel. In a system employing carrier aggregation the DL scheduling information related to a certain data transmission may be transmitted on a component carrier other than the data transmission. Transmission of a data and scheduling information on different component carriers is referred to as cross-carrier scheduling.

In a cell operated on unlicensed spectrum a communication device may start monitoring channel elements related to a DL control channel carrying scheduling information after detection of DL data burst or subframe in the cell. The detection of the DL data burst or subframe may be based on the detection of a certain signal in the cell, for example a reference signal, such as a cell reference signal which the communication device may blindly detect, or based on explicit signaling indicative of the presence of the DL data burst (such as common DCI). Monitoring channel elements related to a DL control channel may comprise blind detection of scheduling information destined to the communication device. The control channel may be a physical downlink control channel (PDCCH) or enhanced physical downlink control channel (EPDCCH) as specified in LTE or a similar channel. The communication device may further detect a DL data transmission on a data channel, such as a physical downlink shared channel (PDSCH) or a similar channel, based on the detected scheduling information.

A communication system may employ a retransmission mechanism, such as Automatic Repeat Request (ARQ), for handling transmission errors. A receiver in such a system may use an error-detection code, such as a Cyclic Redundancy Check (CRC), to verify whether a data packet was received in error. The receiver may notify the transmitter on a feedback channel of the outcome of the verification by sending an acknowledgement (ACK) if the data packet was correctly received or a non-acknowledgement (NACK) if an error was detected. The transmitter may subsequently transmit a new data packet related to other information bits, in case of an ACK, or retransmit the data packet received in error, in case of a NACK. The retransmission mechanism may be combined with forward error-correction coding (FEC), in which redundancy information is included in the data packet prior to transmission. This redundancy information can be used at the receiver for correcting at least some of the transmission errors, and retransmission of a data packet is only requested in case of uncorrectable errors. Such a combination of FEC and ARQ is referred to as hybrid automatic repeat request (HARQ). In a HARQ scheme the receiver may not simply discard a data packet with uncorrectable errors, but may combine obtained information with information from one or more retransmissions related to the same information bits. These retransmissions may contain identical copies of the first transmission. In more advanced schemes, such as incremental redundancy (IR) HARQ, the first transmission and related retransmissions are not identical. Rather, the various transmissions related to the same information bits may comprise different redundancy versions (RV), and each retransmission makes additional redundancy information available at the receiver for data detection. The number of transmissions related to the same information bits may be limited in a communication system by a maximum number of not successful transmissions, and a data packet related to new information bits may be transmitted once the maximum number of not successful transmissions has been reached. A scheduling grant may comprise a new data indicator (NDI) notifying a communication device whether the scheduled transmission is destined for a data packet related to new information bits. Further or alternatively, the scheduling grant may comprise an indication of the redundancy version (RV) used or to be used in the transmission. Each data packet, often referred to as transport block, may be transmitted in a communication system within a transmission time interval (TTI), such as a subframe in LTE. At least two transport blocks may be transmitted in parallel in a TTI when spatial multiplexing is employed. Processing of a transport block, its transmission and the processing and transmission of the corresponding HARQ-ACK feedback may take several TTIs. For example, in LTE-FDD such a complete HARQ loop takes eight subframes. Accordingly, eight HARQ processes are needed in a data stream in LTE-FDD for continuous transmission between an access node and a communication device. The HARQ processes are handled in the access nodes and the communication devices in parallel, and each HARQ process controls the transmission of transport blocks and ACK/NACK feedback related to a set of information bits in the data stream.

In a conventional LTE system HARQ-ACK feedback is communicated in UL according to a predefined timing in relation to the transmission time interval in which a transport block has been transmitted in DL. Specifically, HARQ-ACK feedback is transmitted by a communication device in subframe n for a DL transport block intended for the communication device and transmitted/detected on PDSCH (Physical Downlink Shared Channel) in subframe n-k. The minimum value for the HARQ-ACK delay k is four subframes in a conventional LTE system, which allows for sufficient time to receive and decode the DL transport block by a communication device, and for preparing the corresponding HARQ-ACK transmission in UL. In FDD mode, HARQ-ACK delay is fixed in 3GPP specification TS 36.213 to the minimum value of four subframes. In other words, when a transport block intended for a communication device is detected on PDSCH by the communication device in subframe n-4, the corresponding HARQ-ACK message is transmitted in subframe n by the communication device. In TDD mode, the HARQ-ACK delay k depends on the selected UL/DL configuration as well as the subframe number in which the transport block is transmitted on PDSCH. The relationship is given by means of the DL association set index K, shown in Table 1 and specified in 3GPP specification TS 36.213. In other words, when one or more transport blocks on PDSCH intended for a communication device are detected by the communication device within subframe(s) n-k (where k ∈ K and K as specified in Table 1), the corresponding HARQ-ACK message is transmitted in subframe n by the communication device.

TABLE 1
Downlink association set index K: {k₀, k₁, . . . k_{M-1}} for LTE-TDD

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

As discussed above, HARQ-ACK feedback is transmitted in a conventional LTE system by a communication device in subframe n for a DL transport block intended for the communication device and transmitted on PDSCH in subframe n-k. However, such a predetermined association between DL data transmissions and HARQ-ACK messages is not longer applicable (or at least such an approach cannot be the only solution to convey HARQ-ACK), due to LBT requirements and/or channel availability problems, when HARQ-ACK messages are communicated on unlicensed bands.

Signal transmissions on unlicensed spectrum may need to occupy effectively the whole of the nominal channel bandwidth, so as to ensure reliable operation with LBT. For example, the ETSI standards set strict requirements for the occupied channel bandwidth (“According to ETSI regulation, the Occupied Channel Bandwidth, defined to be the bandwidth containing 99% of the power of the signal, shall be between 80% and 100% of the declared Nominal Channel Bandwidth.”). With a nominal channel bandwidth of a radio carrier of for example 20 MHz in a LTE-LAA system, this means that a transmission should have a bandwidth of at least 0.80*20 MHz=16 MHz.

This means that UL transmissions such as PUCCH and PUSCH are required to occupy a large bandwidth, which is possible by using interleaved frequency division multiple access (IFDMA), block-IFDMA, or contiguous resource allocation.

In another non-limiting example, in case of LTE stand-alone unlicensed band operation (or MulteFire system), everything is subject to LBT. In case of stand-alone case, there is no licensed band coverage and there is no possibility to use such. This means that both base station (eNB) or user equipment (UE) communication is subject to the success of LBT procedure. Neither UE or eNB can transmit anything if the result of clear channel access procedure is negative (i.e. the energy detection has not identified a clear channel, ready that could be used). Similar procedure could be used also in future LTE-like system (e.g. 5G).

In a stand-alone system on unlicensed band/carrier the mobility or measurements become more challenging compared to a licensed system e.g. LTE system on licensed carrier. This is due to regulations requiring that a successful LBT/CCA before transmitting. As the LBT/CCA is applied on both eNB and UE side, even the transmission of reference signals are subject to LBT. This implies that if UE will try to measure neighbour cell(s), it should know first of all when the measuring timing window is. DMTC (Discovery Signal Measurement Timing Configuration) is in essence a time unit, the time when the UE does measurements. DMTC is UE specific and RRC configured. On eNB side, DTxW (DRS transmission window) is transmitted periodically e.g. 40 ms periodicity and the transmission occasion or opportunity (TxOP) length could be e.g. 6 ms.

In case UE has knowledge about DTxW, this means that NW is synchronous and the measuring timings are known by the UE. But in case of asynchronous NW, these time instances are not fully known by the UE (unless would know the offset the other cell(s) have) and therefore measuring neighbours could prove not a successful operation (despite LBT being successful).

Classifying these measurements from intra-f and inter-f point of view: a) In case of intra-f case, the impact of not having known synch channel (DRS) location information is at least on UE power consumption; b) in case of inter-f: in case UE has separate receiver in use then we have to deal with similar challenge as for intra-f, while if the UE does not have separate receiver, then gap assisted is needed, i.e. in essence it is not possible to use similar gaps as known currently if not synchronized.

Currently, according to TS.36.300, when LAA is configured, the eNB configures the UE with one DMTC window for all neighbor cells as well as for the serving cell (if any) on one frequency. The UE is only expected to detect and measure cells transmitting DRS during the configured DRS DMTC window.

Cell measurements and cell search may use a discovery measurement configuration (DMTC), similar to the DMTC specified in LTE for the detection of discovery reference signals (DRS) from dormant eNB, that is eNBs being in OFF state.

A dormant eNB may in LTE transmit DRS (e.g. periodically) DRS to allow for UEs supporting the feature to discover and measure the dormant cell. In LTE, once the network is satisfied that there are no longer UEs in the cell (after HO, connection release and redirecting RRC_IDLE mode UEs to different frequency layers) it can make the final decision to turn off the cell and start a dormancy period. During the dormancy period, an eNB may transmit (e.g. periodically) DRS to allow for UEs supporting the feature to discover and measure the dormant cell. At some point in time, the network can decide to turn the cell back, for example, based on UE measurements.

The DRS in LTE consists of synchronization and reference signals introduced already in LTE Rel.8: PSS, SSS, and CRS. Additionally, CSI-RS standardized in Rel-10 can also be configured as part of DRS. The PSS/SSS/CRS facilitate cell discovery and RRM measurements similar to normal LTE operation while the CSI-RS allows for discovery of transmission points within the cell, enabling, for example, the so-called single-cell CoMP operation via RSRP measurements.

The DRS in LTE are transmitted with a more sparse periodicity for the purpose of cell detection and RRM measurements. One instance of DRS transmission is denoted as DRS Occasion. A DRS Occasion has duration of 1-5 subframes and includes PSS/SSS and CRS corresponding to antenna port 0 in the same time/frequency locations as in ordinary LTE operation. Additionally, a DRS Occasion may comprise of transmission of several CSI-RS resources, each typically corresponding to a transmission point. In other words, DRS occasion can be seen as a snapshot of an ordinary LTE transmission on an unloaded carrier.

The UE performs discovery measurements according to eNB-given per-carrier Discovery Measurement Timing Configuration (DMTC). The DMTC indicates the time instances when the UE may assume DRS to be present for a carrier, similar to measurement gap configurations used for inter-frequency RRM measurements. A DMTC occasion in LTE has a fixed duration of 6 ms and a configurable periodicity of 40, 80 or 160 ms. The network needs to ensure that the transmission times of DRS occasions of all cells on a given carrier frequency are aligned with the DMTC configuration in order to ensure those cells can be discovered. Hence, the network needs to be synchronized with the accuracy of approximately one subframe (or better) for the discovery procedure to work. The network may also not configure a UE to use all DRS occasions for the DMTC in LTE.

The DRS-based UE measurements in LTE differ slightly from legacy measurements:
The UE may only assume presence of CRS/CSI-RS only during the DMTC.
The DRS-based CRS (RSRP/RSRQ) measurements are done as in legacy UE. This means the same measurement events (i.e, events A1-A6) are also applicable and all legacy options (e.g. cell-specific offsets) can be utilized.
For the DRS-based CSI-RS measurements, only CSI-RS-based RSRP is supported. The network also explicitly configures the CSI-RS resources that the UE measures, and UE only triggers measurement reports for those CSI-RS resources.
Two new measurement events have been defined for DRS-based CSI-RS measurements:
   The event Cl compares the measurement result of a CSI-RS resource against an absolute threshold value (similar to the existing event A4).
The event C2 compares the measurement result of a CSI-RS resource against the measurement result of a pre-defined reference CSI-RS resource (similar to the existing event A3).

### SUMMARY

In a first aspect, there is provided a method comprising receiving information indicative of a discovery signal timing measurement configuration comprising a first measurement phase associated with a first periodicity and at least one second measurement phase associated with a second periodicity, and using the discovery signal measurement configuration for measurement reporting.

The discovery signal timing measurement configuration may further comprises offset information specifying the initial time offset between the first measurement phase and the at least one second measurement phase.

The first measurement phase may be associated with a first radio carrier frequency and the at least one second measurement phase may be associated with a second radio carrier frequency.

The first measurement phase may be configured to occur during detection reference signal transmission occasions of a first cell.

The second measurement phase may be configured to occur during detection reference signal transmission occasions of a second cell.

The second measurement periodicity may not be an integer multiple of the periodicity of detection reference signal transmission occasions of the first cell.

In a second aspect, there is provided a method comprising causing transmission of information indicative of a discovery signal timing measurement configuration comprising a first measurement phase associated with a first periodicity and at least one second measurement phase associated with a second periodicity.

The discovery signal timing measurement configuration may further comprises offset information specifying the initial time offset between the first measurement phase and the at least one second measurement phase.

The first measurement phase may be associated with a first radio carrier frequency and the at least one second measurement phase may be associated with a second radio carrier frequency.

The first measurement phase may be configured to occur during detection reference signal transmission occasions of a first cell.

The second measurement phase may be configured to occur during detection reference signal transmission occasions of a second cell.

The second measurement periodicity may not be an integer multiple of the periodicity of detection reference signal transmission occasions of the first cell.

In a third aspect, there is provided an apparatus, said apparatus comprising at least one processor; and at least one memory including computer program code, the at least one memory and the computer program code configured, with the at least one processor, to cause the apparatus at least to receive information indicative of a discovery signal timing measurement configuration comprising a first measurement phase associated with a first periodicity and at least one second measurement phase associated with a second periodicity, and use the discovery signal measurement configuration for measurement reporting.

In a forth aspect, there is provided an apparatus, said apparatus comprising at least one processor; and at least one memory including computer program code, the at least one memory and the computer program code configured, with the at least one processor, to cause the apparatus at least to cause transmission of information indicative of a discovery signal timing measurement configuration comprising a first measurement phase associated with a first periodicity and at least one second measurement phase associated with a second periodicity.

In a fifth aspect, there is provided an apparatus comprising means for performing a method according to embodiments of the first aspect.

In a sixth aspect, there is provided an apparatus comprising means for performing a method according to embodiments of the second aspect.

In a seventh aspect, there is provided a computer program product for a computer, comprising software code portions for performing the steps of a method according to embodiments of the first aspect.

In an eighth aspect, there is provided a computer program product for a computer, comprising software code portions for performing the steps of a method according to embodiments of the second aspect.

In a ninth aspect, there is provided a mobile communication system comprising at least one apparatus according to the third aspect and at least one apparatus according to the forth aspect.

In a tenth aspect, there is provided a mobile communication system comprising at least one apparatus according to the fifth aspect and at least one apparatus according to the sixth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a timing diagram according to an embodiment of the present invention;

FIG. 4 shows a timing diagram according to a further embodiment of the present invention;

FIG. 5 shows a schematic diagram of an example control apparatus;

### DETAILED DESCRIPTION

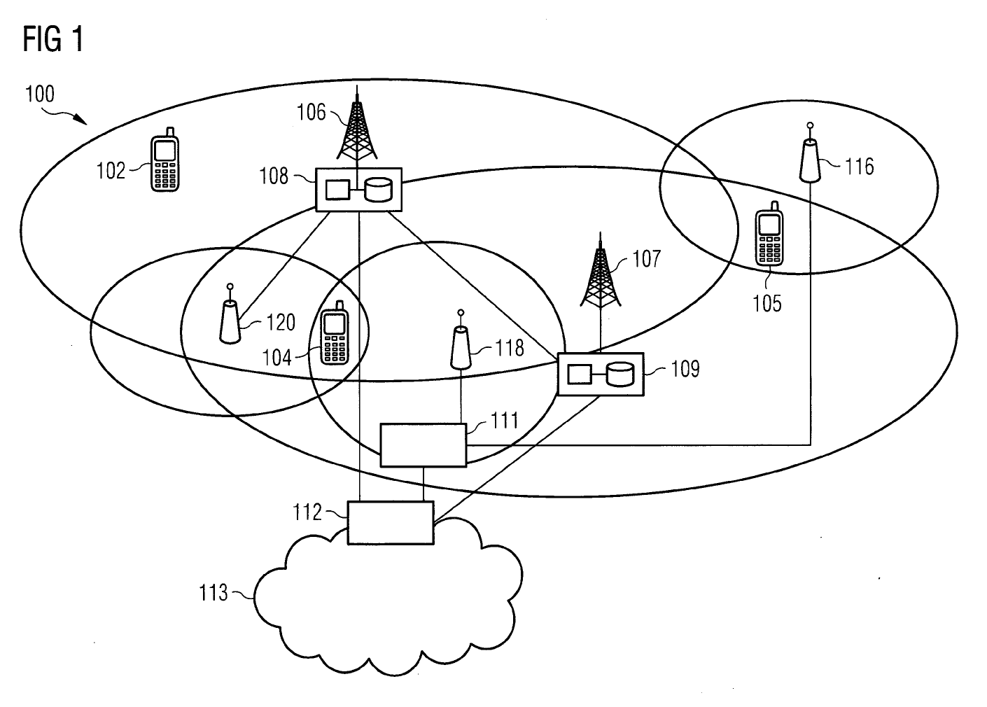

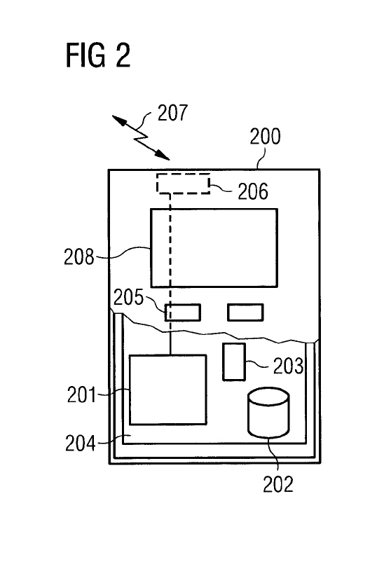

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signaling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

For example in LAA or MulteFire system the DMTC may be used for indicating the UE when it should measure the cells on an unlicensed carrier. The indication may be given on a per carrier basis so that the DMTC applies to a specific carrier. On an unlicensed carrier a successful LBT/CCA may be needed before the eNB is allowed to transmit, and this may apply to transmission of DRS as well. Outside DTxW the eNB may not even try to access the channel to transmit anything, unless there is some user data to transmit.

The DMTC then indicates the UE the timing when it is to measure the DRS transmitted by the cells on a carrier. UE may not be allowed to consider discovery signals transmission in subframes outside the DMTC occasion.

In unsynchronized deployment where the cells on the carrier may have different timing of DRS transmission it may not be possible to find a suitable timing for a DMTC window that would cover the DRS transmission occasions of all the cells. So to catch (i.e. measure when those cells are attempting to transmit DRS) all the cells the UE would need to measure continuously, which would negatively impact UE power consumption and measurement performance as the the timing of the DRS transmission would be unknown. Or the UE would need to measure with a pattern that it is not having the periodicity that is the same or integer multiple of the DTxW (DRS transmission window) periodicity to make sure that all the possible DRS transmission timings are covered eventually. In the latter approach the problem is that the delay of detecting or measuring cells can increase substantially.

The problem there is that if the cells on a carrier have DRS transmission occasions i.e. DTxW repeating with a periodicity of e.g. 40 ms, there is no good DMTC configuration would cover the DTxW of all the cells that are unsynchronized. There has been a proposal (from Ericsson) to have a sliding DMTC configuration with a periodicity not divisible by DTxW periodicity, so e.g. 45 ms. This kind of DMTC would in a sense slide in relation to possible DTxW timings that have 40 ms periodicity. But the drawback is that it can take a long time until a cell with certain timing is measured, and time between successive measurements of the same cell are then far apart (8×40 ms). The problem is especially that also the serving cell would be then measured infrequently (7 out of 8 DMTC windows would not overlap serving cell DTxW i.e. DRS transmission). One crucial aspect is to find a balance between a) on one hand UE should measure more often in order to find other cells (e.g. in order to have a reliability in mobility measurements) and b) UE should not measure that often, in order to be able to save the power consumption.

### Definitions:

DTxW: defines the periodic window when the eNB attempts DRS transmissions
DMTC: defines when the UE shall attempt to detect and measure the serving and neighbor cells' DRSs

Our proposed solution to improve the measurement performance and accuracy is to configure UE with two DMTC windows simultaneously per carrier frequency:
1. DMTC for serving cell measurements following the DTxW periodicity
2. DMTC for detecting/measuring other (neighbor) cells
The reasoning here is that the timing of the serving cell DRS transmission is known, so no need to sweep.
Moreover, there should probably be measurements of the serving cells (at least PCell) more frequently than neighbor cell measurements
On the other hand, neighbor cell discovery and measurements need e.g. a sweeping DMTC (or a different DMTC configuration) if DTxW are unsynchronized
These could also be seen as a DMTC pattern with varying periodicity.

In an example embodiment of the invention, the network configures the UE with two separate DMTC for a carrier frequency. The first DMTC could be a cell specific DMTC that is intended for measuring a single cell, e.g. just a serving cell, or group of cells with a specific timing. The second DMTC could be a carrier specific DMTC that is intended for measuring unsynchronized cells on a carrier (the periodicity of the second DMTC could be matching with the DTxW).

Configuring is particularly beneficial in a deployment where the cells are not synchronized on the carrier. The first DMTC is used for indicating the suitable measurement occasions of the serving cell. For instance, it could be aligned with the DTxW (or possible window of DRS transmission) of the serving cell. The second DMTC is used for indicating when to measure neighbor cells on the (e.g. same) carrier. For example in a scenario where the timing of DTxW in the neighbor cells on the carrier is unknown or not aligned with serving cell's timing, the second DMTC can be configured to be such that it indicates UE when to measure the neighbor cells. In the case that the DTxW timing of neighbor cells on the carrier is dispersed or spread in time, the second DMTC window may be configured such that it is not fully aligned with DTxW of any particular cell but instead sweeping over different possible DTxW timings. This sliding/sweeping could in practice be a DMTC window of e.g. 6 ms with a periodicity that is not an integer multiple of the DTxW periodicity used by the neighbor cells. So if the DTxW periodicity is e.g. 40 ms, the sliding DMTC could have a periodicity of 45 ms. This means that the DMTC window is timing is shifting relative to the DTxW timing. (These are meant to be non-limiting example values and other values or types of DMTC patterns sweeping different DTxW timings could be used as well.)

The drawback of the sweeping DMTC pattern is that it can take a long time until a cell with a certain timing is measured and the time between successive measurements of the same cell are then far apart (8×40 ms if the DMTC overlaps with DTxW only 1 out of 8 times due to different periodicity of DMTC and DTxW). The problem is especially that also the serving cell may be then measured infrequently, which can lead to mobility robustness problems and compromise the RLM (radio link monitoring) and triggering of radio link failure (RLF). This is the case in particular if UE's measurements are restricted to within the configured DMTC either by specification requirements or due to eNB not having transmissions outside this time e.g. due to low traffic activity.

The DMTC configuration could be signalled to the UE for example as broadcast signalling in system information (e.g. in eSIB). Alternatively dedicated signalling for example using RRC signalling could be used for giving the UE the DMTC configuration.

In an example embodiment of the invention the UE is indicated a single DMTC for a carrier measuring the serving cell and in addition information (e.g. a one bit indication) whether the same DMTC is applicable to the neighbor cells as well (i.e. those cells have their DTxW synchronized with the serving cell). If the UE is indicated that the same DMTC window applies to neighbor cells as well, it may in some cases measure only within that DMTC. Such case could be for example a UE in IDLE mode, or if UE is to ignore DRS transmission detected outside the DMTC occasion.

An indication from eNB to UE could also directly indicate whether the cells on the carrier are synchronized or not. Based on this information the UE could determine whether to apply the configured DMTC for only serving cell measurements or also neighbor cell detection and measurements on the carrier.

A specific DMTC could be used for indicating that there is no accurate synchronization information, e.g. 40 ms periodicity with 40 ms window duration. This could be the only DMTC configured for a carrier, or it could the carrier specific DMTC whereas another cell specific DMTC giving more precise timing information would be configured in addition for measuring the serving cell. The configuration could also indicate the periodicity but no window start offset so that the periodicity information could be still used by the UE and it could the basis for the UE measurement requirements (i.e. the required time to e.g. detect or measure cells would depend on the given periodicity).

The intention of the DMTC is to indicate the DRS transmission occasions of the cells, so basically it should coincide with the DTxW. This works actually well in a synchronized setup such as LAA or LTE small cell on/off. But for unsynchronized network (e.g. MulteFire network), this may lead to problems.

Two possible approaches with some drawbacks: 1. Almost continuous DMTC, which enables measuring all the cells, but has the major drawback that it doesn't essentially convey any information of the DTxW timing, and 2. Sweeping pattern that also finds all the cells eventually, but can take a long time.

In one example embodiment, serving cell is frequently measured (important for maintaining a robust connection, knowing when system info is broadcasted) and neighbor cells are searched/measured less frequently but with a sweeping DMTC so that all timings can be found.

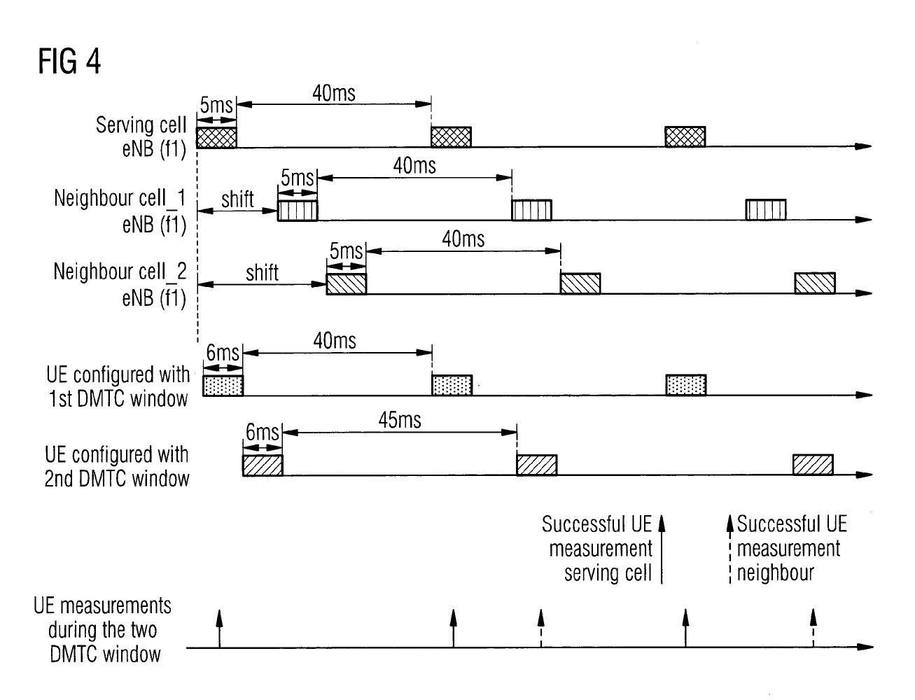

In another exemplary embodiment, the DMTC pattern may be interpreted as a single DMTC pattern that has variable periodicity. We should have something about that in the application. For example, instead of configuring UE with two separate DMTC patterns, the benefits of this invention could be also achieved by defining and configuring UE a DMTC pattern with varying periodicity. This pattern could be such that it catches every DTxW of the serving cell and is additionally sweeping different possibly DTxW timing for detecting and measuring neighbor cells. One example way to construct such a pattern is to combine the two DMTC patterns in FIG. 4 so that the DMTC is a union of those two separate patterns.

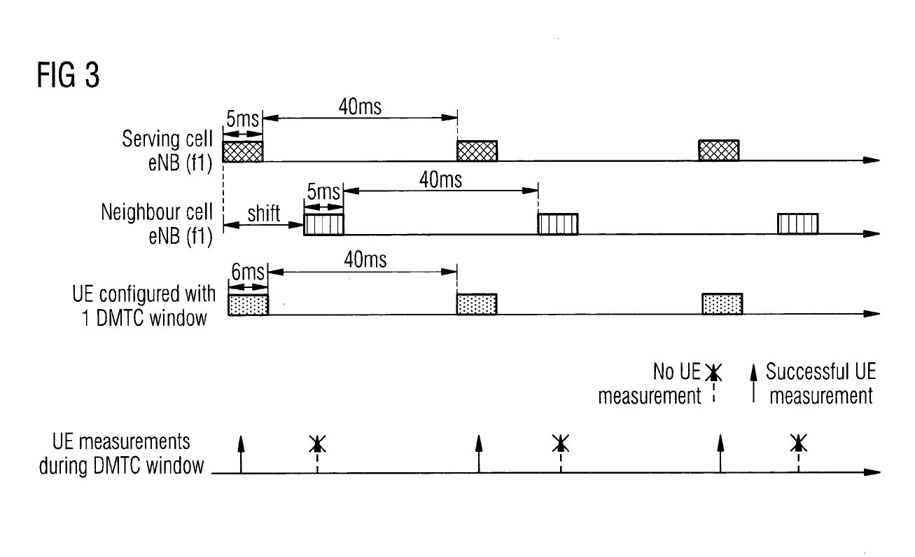

FIG. 4 represents an example the illustration of the proposed idea. UE is configured with 2 DMTC windows for a carrier. The 1st DMTC window configuration for the UE is for measuring serving cell, while the 2nd DMTC window configuration for the UE is for measuring neighbours cells. In this example, the neighbour cells are on same frequency than serving cell, but they are not synchronized with serving cell. If UE would have only one DMTC window (as in FIG. 3), then the UE would not be able to catch to measure the neighbour cells. But in case UE is configured with two DMTC windows (as in FIG. 4), UE will be able to catch and measure both serving cell and some of the neighbouring cells. On the other hand, if UE would have only 2nd DMTC window configuration (as in FIG. 4), UE would be able to measure both neighbour cells and serving cell, but with longer delay between measurements of the serving cell, which would adversely affect the measurement accuracy of the serving cell (mobility robustness and radio link monitoring).

In another exemplary example, it is possible to vary the pattern to have e.g. only every second or third DTxW of the serving cell measured, or increase or reduce the rate at which other timings are sweeped (these depend on the duration and periodicity of the second DMTC pattern). The resulting pattern is also efficient to signal to the UE (in the two parts, or using a fixed periodicity pattern for serving cell DMTC and a sweeping configuration for the other cells, or simply a single bit indication whether there is need to search for other cells outside the DMTC—indicated depending on whether the network is synchronized).

The DMTC could be even more flexible and configurable. In another example, forming the pattern out of those two parts (one serving cell specific, one carrier specific) could be an efficient way to get it signalled.

Another example embodiment could be the one where UE is given only a single DMTC pattern (basically legacy pattern with 40, 80 or 160 ms periodicity as in current LTE spec) for the serving cell (i.e. aligned with the serving cell DTxW periodicity and having DMTC periodicity that it an integer multiple of DTxW periodicity) and a one bit indication whether that applies to all the cells on the carrier or UE should also search cells with other timing. Or DMTC with fixed periodicity matching with DTxW periodicity (e.g. 40 ms, 80 ms, 160 ms) pattern for serving cell and periodicity for the sweep. It would be then up to the UE implementation to do the measurements of other cells using for example some kind of sweeping over different timings.

In an exemplary embodiment, the network could configures UE with (at least one of or both) a first DMTC and a second DMTC for a carrier; where the first DMTC is cell-specific (intended for measuring the serving cell) and the second DMTC is carrier-specific (intended for measuring neighbor cells). The first DMTC is configured to be at least partly aligned with DRS transmission occasions (or DTxW) of the serving cell. The second DMTC is configured to enable detecting cells with non-synchronized DRS timing (DTxW). The second DMTC has a periodicity that is not an integer multiple of DTxW periodicity of the neighbor cells on the carrier. The second DMTC is an indication that the cells on the carrier are not synchronized. The second DMTC indicates the periodicity of DTxW (or DRS transmission) of neighbor cells on the carrier. The second DMTC indicates the window duration equal to periodicity (e.g. 40 ms duration with 40 ms periodicity)

On the UE side, UE receives from the network a first and second configuration of DMTC for a carrier frequency. UE detects and measures cells on the carrier frequency according to the configured first and second DMTC. UE measures the serving cell according to the first DMTC. UE reads system information from the serving cell according to the timing indicated in the first DMTC. UE measures neighbor cells according to the second DMTC. UE measurement periodicity (or rate) depends on the periodicity of the DMTC: Measure more frequently if shorter DMTC periodicity.

It should be understood that each block of the flowchart of the Figures and any combination thereof may be implemented by various means or their combinations, such as hardware, software, firmware, one or more processors and/or circuitry.

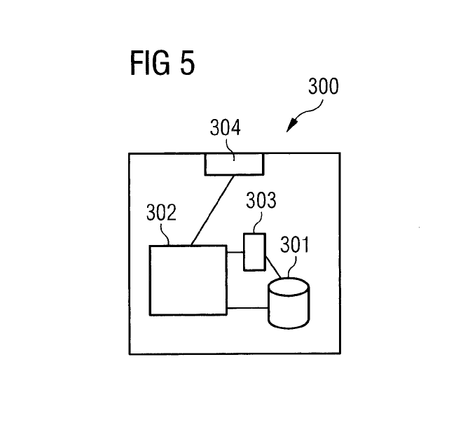

The method may be implemented on a mobile device as described with respect to FIG. 2 or control apparatus as shown in FIG. 5. FIG. 5 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise providing configuration information for measurement in unsynchronized deployments.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE networks, similar principles may be applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving information indicative of a discovery signal measurement timing configuration comprising a first measurement phase associated with a first periodicity and at least one second measurement phase associated with a second periodicity; and
using the discovery signal measurement timing configuration for measurement reporting.

2. A method according to claim 1, wherein the discovery signal measurement timing configuration further comprises offset information specifying the initial time offset between the first measurement phase and the at least one second measurement phase.

3. A method according to claim 1, wherein the first measurement phase is associated with a first radio carrier frequency and the at least one second measurement phase is associated with a second radio carrier frequency.

4. A method according to claim 1, wherein the first measurement phase is configured to occur during discovery reference signal transmission occasions of a first cell.

5. A method according to claim 1, wherein the second measurement phase is configured to occur during discovery reference signal transmission occasions of a second cell.

6. A method according to claim 4, wherein the second measurement periodicity is not an integer multiple of the periodicity of discovery reference signal transmission occasions of the first cell.

7. A method comprising:
causing transmission of information indicative of a discovery signal timing measurement configuration comprising a first measurement phase associated with a first periodicity and at least one second measurement phase associated with a second periodicity; and
receiving measurement reporting based on the discovery signal measurement timing configuration.

8. A method according to claim 7, wherein the discovery signal timing measurement configuration further comprises offset information specifying the initial time offset between the first measurement phase and the at least one second measurement phase.

9. A method according to claim 7, wherein the first measurement phase is associated with a first radio carrier frequency and the at least one second measurement phase is associated with a second radio carrier frequency.

10. A method according to claim 7 wherein the first measurement phase is configured to occur during discovery reference signal transmission occasions of a first cell.

11. A method according to claim 7, wherein the second measurement phase is configured to occur during discovery reference signal transmission occasions of a second cell.

12. A method according to claim 7, wherein the second measurement periodicity is not an integer multiple of the periodicity of discovery reference signal transmission occasions of the first cell.

13. An apparatus comprising:
at least one processor; and
at least one memory including computer program code, the at least one memory and the computer program code configured, with the at least one processor, to cause the apparatus to perform at least the following:
receive information indicative of a discovery signal timing measurement configuration comprising a first measurement phase associated with a first periodicity and at least one second measurement phase associated with a second periodicity; and
use the discovery signal measurement configuration for measurement reporting.

14. An apparatus comprising:
at least one processor; and
at least one memory including computer program code, the at least one memory and the computer program code configured, with the at least one processor, to cause the apparatus to perform at least the following:
cause transmission of information indicative of a discovery signal timing measurement configuration comprising a first measurement phase associated with a first periodicity and at least one second measurement phase associated with a second periodicity; and
receiving measurement reporting based on the discovery signal measurement timing configuration.

15-18. (canceled)

19. A computer program product comprising a non-transitory computer-readable storage medium bearing computer program code embodied therein for use with a computer, the computer program code comprising code for performing the method of claim 1.

20. A computer program product comprising a non-transitory computer-readable storage medium bearing computer program code embodied therein for use with a computer, the computer program code comprising code for performing the method of claim 7.

21. An apparatus according to claim 13, wherein the discovery signal measurement timing configuration further comprises offset information specifying the initial time offset between the first measurement phase and the at least one second measurement phase.

22. An apparatus according to claim 13, wherein the first measurement phase is associated with a first radio carrier frequency and the at least one second measurement phase is associated with a second radio carrier frequency.

23. An apparatus according to claim 13, wherein the first measurement phase is configured to occur during discovery reference signal transmission occasions of a first cell.

24. An apparatus according to claim 13, wherein the second measurement phase is configured to occur during discovery reference signal transmission occasions of a second cell.
